(19) United States
(12) Patent Application Publication
(10) Pub. No.: US 2012/0230484 A1
(43) Pub. Date: Sep. 13, 2012

(54) Audo-Dial Connection Into Conference Calls with Attendee Status Broadcast

(75) Inventors: Kenneth Kannappan, Palo Alto, CA (US); Gunjan Bhow, Menlo Park, CA (US)

(73) Assignee: Plantronics, Inc., Santa Cruz, CA (US)

(21) Appl. No.: 13/044,734

(22) Filed: Mar. 10, 2011

(51) Int. Cl. H04M 3/42

(52) U.S. Cl. 379/202.01

(57) ABSTRACT

Methods and systems for dialing into conference calls are presented. A meeting reminder is displayed and a conference call confirmation instruction, delay instruction, or cancellation instruction is received from a meeting attendee. Responsive to receiving a delay instruction, a delayed call-in time is established and a status message is sent to all meeting attendees. The conference call dial-in number is automatically dialed at the proposed or delayed time.

### RELATED APPLICATIONS

The present application is related to commonly assigned, co-pending U.S. patent application Ser. No. 12/252,843 filed on Oct. 16, 2008, and entitled “Auto-Dial and Connection into Conference Calls”, the full disclosure of which is incorporated herein by reference.

### BACKGROUND OF THE INVENTION

As the modern workforce becomes increasingly mobile and distributed geographically, many meetings are held using a telephone conference call, with some or all attendees calling (also referred to herein as “dialing in”) into the conference call. Typically, potential attendees of the telephone conference call are sent a meeting request by the meeting organizer or participant via an office email/calendaring application such as Microsoft Outlook. The meeting request notification message is often in the form of a specialized meeting request email which provides the recipient with various response options, including whether to accept or reject the meeting request. The meeting request notification may also be in the form of electronic messages, such as SMS messages. The meeting request may also be a standard email offering the recipient no response options. The meeting request is usually very tightly integrated with the scheduling/calendaring system in addition to the email system. Indeed, in one example the email itself may not be generated by a human user, but from the calendaring/scheduling software system as a result of a meeting being scheduled. Information related to the meeting, such as time and place is included in various data fields of the meeting request. For example, meeting information may be found in a “Subject” data field, “Notes” data field, “Description” data field, or other similar data field. The particular nomenclature, type, and number of data fields in the meeting request varies based on the particular email/calendaring application used.

The meeting request may or may not pertain to a telephone conference call. Where the meeting request is a request to participate in a telephone conference call, the meeting request typically includes a dial-in telephone number used to call into the telephone conference. The meeting request also typically includes a conference identification number that the attendee enters once the call to the dial-in number is connected. The conference identification number enables the conference call system to locate the desired conference call to join the attendee calling in. The meeting request may include a user identification number specific to the meeting request recipient that the attendee may enter once the call is connected. For example, the user identification number may identify the attendee as the conference call leader or other designation. Though the meeting organizer will typically place the dial-in telephone number and conference identification number in the “Description” or “Notes” data field, it may also be placed in other data fields. Information necessary to connect to the conference call is often referred to as dial-in information.

In the prior art, to participate in the telephone conference call, at the time of the meeting the attendee must locate the dial-in number, conference identification number, and possibly user identification number. Typically, the attendee opens the calendar item or email corresponding to the meeting on the electronic calendar on his personal computer or mobile phone, looks up the number for dialing in and then dials it manually. The attendee may need to manually write the number down on paper to assist him in making the call. Once the call is connected, the attendee must then enter the conference identification number and user identification number.

This process is cumbersome and has several limitations. The attendee must manually look up, remember, and key in the dial-in number. Once connected, the attendee must manually enter the conference identification number (also referred to herein as the meeting identification number or conference call identification number) and possibly the user identification number if applicable. If the attendee makes mistake in keying in any of these numerical strings, an error occurs and the attendee must begin again.

Where the meeting information is stored on the attendee's personal computer, if the personal computer is off, significant time is required to access the dial-in number as the personal computer must be booted up. Where the meeting information is stored on the attendee's mobile phone or smartphone, it may not be safe or practical to look up the small digits in the mobile phone or smartphone and note them down before initiating the call. This is particularly true if the attendee is traveling in an automobile or busy with other activities.

Oftentimes, the meeting attendee may not be able to participate in the call at the scheduled time. For example, where the attendee is currently driving to a desired destination, the attendee may wish to delay participation in the meeting. In the prior art, if the attendee wishes to inform the other attendees that he will be delayed, the attendee must manually type an appropriate message and add each addressee to the recipient list. In addition to being inconvenient, this is neither safe nor practical when the attendee is mobile, particularly when driving. Furthermore, when the attendee is able to join the call, he must manually initiate the call.

As a result, there is a need for improved methods and systems for connecting telephone conference call attendees.

### BRIEF DESCRIPTION OF THE DRAWINGS

The present invention will be readily understood by the following detailed description in conjunction with the accompanying drawings, wherein like reference numerals designate like structural elements.

FIG. 1 illustrates receiving a meeting request at several types of user computing devices.

FIG. 2 illustrates auto-dialing into a dial-in location using several types of user computing devices.

FIG. 3 illustrates a meeting request received at a user computing device.

FIG. 4 illustrates a calendar item corresponding to the meeting request shown in FIG. 3, where the meeting request has been accepted by a user.

FIG. 5 illustrates a conference call reminder/instruction request prompt.

FIG. 6 illustrates a system for audio-dialing into a dial-in location in one example.

FIG. 7 illustrates a system for audio-dialing into a dial-in location in a further example.

FIG. 8 illustrates a broadcast status message sent to meeting attendees in one example.

FIG. 9 illustrates a broadcast status message sent to meeting attendees having attendee location information in one example.

FIG. 10 illustrates a broadcast status message sent to meeting attendees having attendee location information in the form of a location map in one example.

FIGS. 11A-11D are a flow diagram illustrating auto-dialing and connection into conference calls in one example.

FIGS. 12A-12E are a flow diagram illustrating auto-dialing and connection into conference calls in a further example.

FIG. 13 illustrates a simplified block diagram of a smartphone in one example implementation.

FIG. 14 is a flow diagram illustrating generating a list of meeting attendees to which status messages are broadcast in one example.

### DESCRIPTION OF SPECIFIC EMBODIMENTS

Methods and apparatuses for auto-dialing and connection into conference calls are disclosed. The following description is presented to enable any person skilled in the art to make and use the invention. Descriptions of specific embodiments and applications arc provided only as examples and various modifications will be readily apparent to those skilled in the art. The general principles defined herein may be applied to other embodiments and applications without departing from the spirit and scope of the invention. Thus, the present invention is to be accorded the Widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

The methods and systems described herein deliver significant ease-of-use to the end-user. More efficient systems and methods are provided for informing other meeting attendees when a given meeting participant will be delayed in calling in to join a telephone conference meeting. Valuable time is saved to an organization due to less time spent by meeting attendees dialing into telephone conference meetings. In one example, a meeting organizer sets up a telephone conference meeting using an office calendaring/email program such as Microsoft Outlook to send invitations out to attendees. As part of this meeting invitation, the “Dial-in information” is included. If the recipient “Accepts” the meeting invitation, on the recipient's computer and/or his mobile smartphone (e.g., a mobile phone running an office calendaring/email program, such as a Blackberry device or Apple iPhone), a resident software program (e.g. a plug-in to Outlook) scans the calendar item, and extracts the phone number as well as the meeting identification (ID) number. If the meeting ID is followed by a leader or a participant code (also referred to herein as a user identification number), the software program also extracts that.

In one example, the resident software program is executed on a PC coupled to a headset base via a USB cable. This headset base in turn is coupled to a landline PSTN phone. In this configuration, the resident software program is capable of controlling the landline PSTN phone to initiate outgoing calls on the PSTN. In one example, the resident software program activates if it detects a headset is connected to the PC. In a further example, the software program on the PC and the smartphone is always active.

A predetermined amount of time prior to the call, such as 1-10 minutes before the scheduled call, the software program running on the user's smartphone or PC prompts the user of the upcoming meeting, and shows three options: dial-in as scheduled (the default selection), dial-in at a delayed time (or “snooze” the dial-in), and cancel. If the user chooses to dial-in, the following occurs: (1) If the user is on a PC connected to a deskphone via a headset base, the software program instructs the headset base via a USB link to dial using the deskphone, (2) If the user is on a PC not connected to a deskphone, the software application dials into the meeting using a softphone application (e.g. Avaya or Skype), or (3) If the user is on a smartphone, the software applications dials in using the mobile phone. After dialing into a meeting, the software application automatically enters the meeting ID number and the leader or participant code as necessary. Furthermore, the software application may use a pre-stored voice signature to announce the user into the meeting.

In one example, the software application sends the dial-in information to a web based server. The server initiates the conference call from the web cloud to the PSTN infrastructure, and then makes another call to the user (e.g., at the user's deskphone, mobile phone, or softphone) to “patch them in”. This has advantage of much more simplicity, robustness, and ubiquity due to independence from the particular kind of deskphone or mobile phone used by the user.

If the user selects to dial in at a delayed time or “snooze” the call-in, the software application automatically generates a recipient list and sends a status message to the other meeting attendees. The software application may email or SMS the status message to the attendees. Alternatively, the software may notify a call management server of the user's selection. The server may then notify the other attendees using an appropriate medium.

The status messages sent by the software application may be pre-programmed and/or pre-selected by a user. For example, a preselected message may state “I will be joining the meeting in approximately [XX] minutes. Please start without me.” or “I'm on the road and will call when it is safe to do so.” Alternatively, the user may select a desired status message content after indicating he wishes to delay dial-in.

In one example, when the user chooses so, the email will be appended with a location map snapshot from a user smartphone in the email to the attendees. This has the added advantage of letting attendees know if the user is an airport, driving in a car, or within some minutes of reaching the office. Advantageously, the sending of status messages by a meeting attendee is more efficient and convenient and safer in mobile applications. Convenience and efficiency are advantageously provided in non-mobile applications.

In one example, a method for dialing into a conference call includes receiving at an attendee computing device a meeting request notification message comprising a meeting request, where the meeting request includes a proposed date and time. The meeting request notification message is opened and the meeting request is displayed on the attendee computing device. An accept meeting instruction or a reject meeting instruction is then received from the attendee. The method further includes scanning a contents of the meeting request notification message to identify a conference call dial-in number and a conference call meeting identification number responsive to receiving the accept meeting instruction. The conference call dial-in number and the conference call meeting identification number are stored in a memory at the computing device, and the meeting request is placed on a calendaring application at the attendee computing device at the proposed date and time.

A meeting reminder is displayed on the attendee computing device at the proposed date and time or a predetermined period prior to the proposed date and time, and a conference call confirmation instruction, delay instruction, or cancellation instruction is received from the attendee. Responsive to receiving the delay instruction, a delayed call-in time is established and a status message is sent to each meeting attendee.

The method further includes automatically calling the conference call dial-in number at the delayed call-in time. A network connection is established with a remote device, and the conference call meeting identification number is transmitted over the network connection to the remote device.

In one example, a computer readable storage medium storing instructions that when executed by a computer cause the computer to perform a method for dialing into a conference call. The method performed by the stored instructions includes receiving at an attendee computing device a meeting request notification message comprising a meeting request, where the meeting request includes a proposed date and time. The meeting request notification message is opened and the meeting request is displayed on the attendee computing device. An accept meeting instruction or a reject meeting instruction is then received from the attendee. The method further includes scanning a contents of the meeting request notification message to identify a conference call dial-in number and a conference call meeting identification number responsive to receiving the accept meeting instruction. The conference call dial-in number and the conference call meeting identification number are stored in a memory at the computing device, and the meeting request is placed on a calendaring application at the attendee computing device at the proposed date and time.

A meeting reminder is displayed on the attendee computing device at the proposed date and time or a predetermined period prior to the proposed date and time, and a conference call confirmation instruction, delay instruction, or cancellation instruction is received from the attendee. Responsive to receiving the delay instruction, a delayed call-in time is established and a status message is sent to each meeting attendee

The method further includes automatically calling the conference call dial-in number at the delayed call-in time. A network connection is established with a remote device, and the conference call meeting identification number is transmitted over the network connection to the remote device.

In one example, a method for dialing into a conference call includes receiving at an attendee computing device a meeting request notification message comprising a meeting request, where the meeting request includes a proposed date and time. The meeting request notification message is opened and the meeting request displayed on the attendee computing device. The method includes receiving an accept meeting instruction or a reject meeting instruction. The contents of the meeting request notification message are scanned to identify a conference call dial-in number and a conference call meeting identification number responsive to receiving the accept meeting instruction. The method includes transmitting the conference call dial-in number and the conference call meeting identification number to a first remote device for storage in a memory of the first remote device. An attendee call-back number input at the attendee computing device by the attendee is received, and the attendee call-back number is transmitted to the first remote device for storage in the memory of the first remote device. The meeting request is placed on a calendaring application at the attendee computing device at the proposed date and time.

The method further includes displaying a meeting reminder on the attendee computing device at the proposed date and time or a predetermined period prior to the proposed date and time. A conference call confirmation instruction, delay instruction, or cancellation instruction is received from the attendee. The method includes responsive to receiving the delay instruction, sending a delay instruction to the first remote device for processing. The method further includes establishing a delayed call-in time at the first remote device and broadcasting a status message to each meeting attendee utilizing the first remote device.

The method includes automatically calling the conference call dial-in number using the first remote device at the delayed call-in time. A network connection is established between the first remote device and a second remote device, and the conference call meeting identification number is transmitted from the first remote device to the second remote device over the network connection. The method includes automatically calling the call-back number using the first remote device, and establishing a second network connection between the first remote device and an attendee telephone. The attendee telephone is linked to the second remote device to join a conference call.

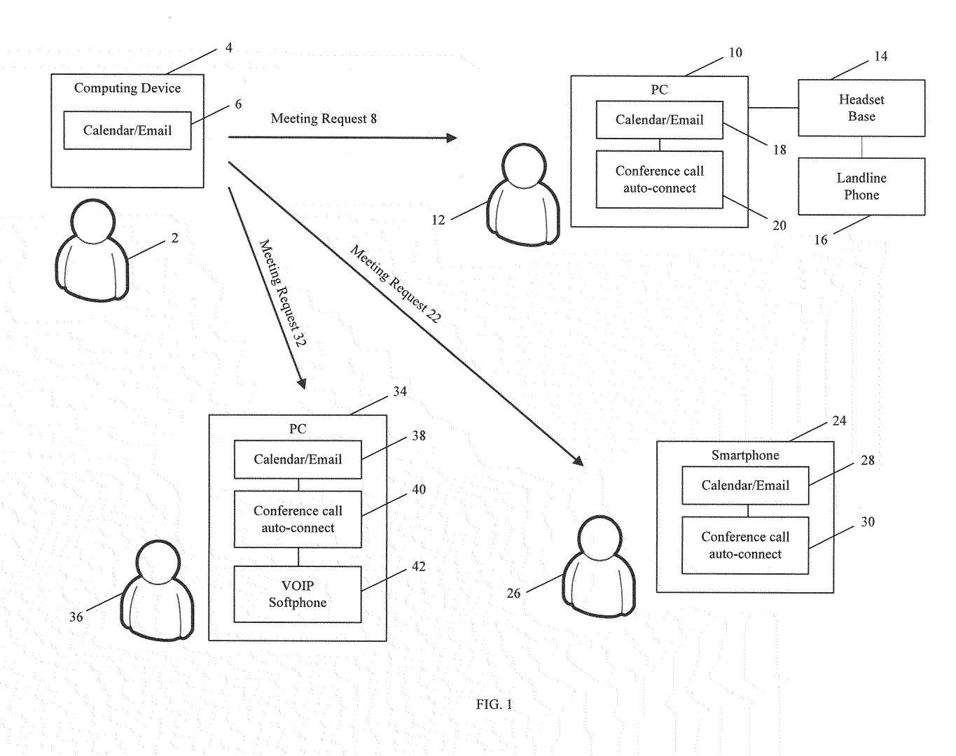

FIG. 1 illustrates receiving a meeting request at several types of attendee computing devices, whereby the meeting request is processed to enable auto-dial in and connection into conference calls. A meeting organizer 2 at a computing device 4 sends out one or more meeting request notification messages to desired attendees using a calendaring/email application 6. The specific calendaring/email application 6 may vary. The meeting request notification message may be a specialized form utilized for meeting requests, or may simply be a standard email where the meeting organizer includes dial-in information somewhere in the email text. The meeting request notification message may be an email, SMS message, or other type of electronic message.

Where the meeting request is a specialized form, the recipient of the meeting request typically has the option of accepting or rejecting the meeting request, and the meeting request is placed on the recipient calendar if accepted using time and date information contained in the meeting request. In one example, the calendaring/email application 6 is a commercially available program such as Microsoft Outlook, Google Calendar, or comparable program. In one example, the meeting request is sent in the form of an email to the desired attendees, either from the email program or the calendar program. Computing device 4 may be any type of computing device capable of running the calendaring/email application 6 including, for example, a notebook computer, personal computer, PDA, or smartphone.

Referring again to FIG. 1, the meeting request may be received by an attendee using a variety of types of computing devices. Generally, the computing devices may be any device capable of executing the applications described herein. In one example, a meeting request 8 sent by meeting organizer 2 is received by an attendee 12 at a personal computer 10, such as a desktop or notebook computer. The personal computer 10 executes a calendar/email application 18 operable to receive and open the meeting request 8. Personal computer 10 also executes a conference call auto-connect application 20 operable to perform the functions and processes described herein. In one example, conference call auto-connect application 20 is a plug-in application to the calendar/email application 18. A headset base station 14 is coupled to personal computer 10, and the headset base station 14 is also coupled to a landline telephone 16 connected to a telephone network such as a public switched telephone network.

In a further example, a meeting request 22 sent by meeting organizer 2 is received by an attendee 26 at a smartphone 24. The smartphone 24 executes a calendar/email application 28 operable to receive and open the meeting request 22. The smartphone also executes a conference call auto-connect application 30 operable to perform the functions and processes described herein.

In a further example illustrated in FIG. 1, a meeting request 32 sent by meeting organizer 2 is received by an attendee 36 at a personal computer 34. The personal, computer 34 executes a calendar/email application 38 operable to receive and open the meeting request 32. Personal computer 34 also executes a conference call auto-connect application 40 operable to perform the functions and processes described herein. In one example, conference call auto-connect application 40 is a plug-in application to the calendar/email application 38. In this example, the conference call auto-connect application 40 is also in communication with a VoIP softphone application 42.

In one example, the conference call auto-connect application includes a text scanning module for processing a contents of a meeting request to identify the presence and values of dial-in information such as the conference call dial-in number and a conference call meeting identification number within the meeting request. In one example, the text scanning module is a text recognition software application programmed to identify telephone numbers and identification numbers. The conference call auto-connect application also includes a dialing module for automatically calling the conference call dial-in number and automatically transmitting the conference call meeting identification number.

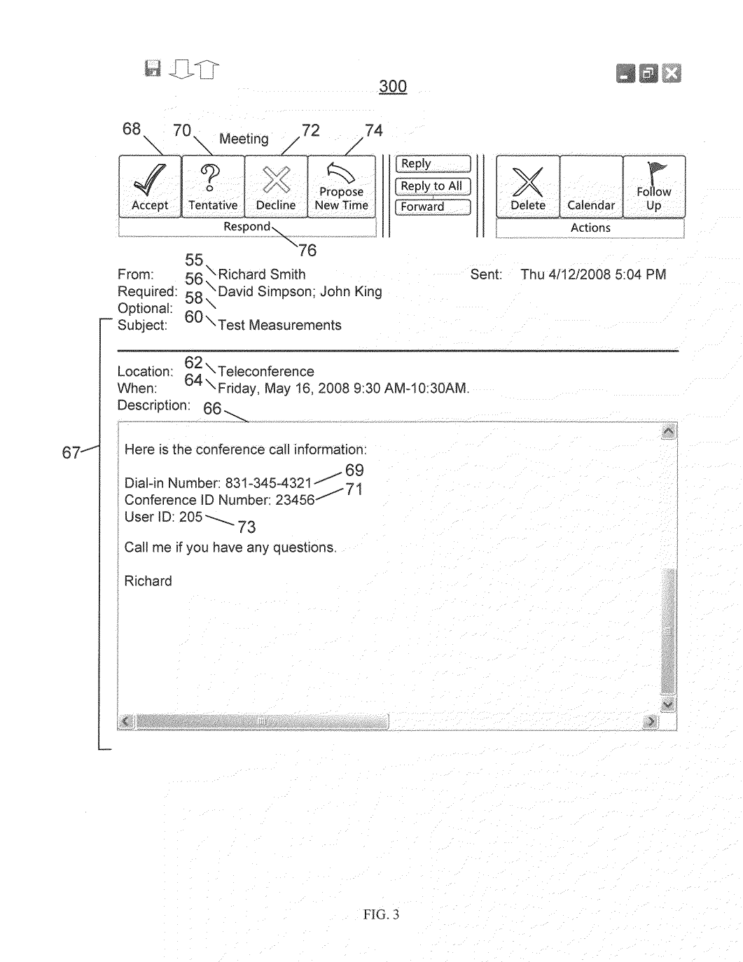

FIG. 3 illustrates a meeting request 300 received at an attendee computing device which has been opened by the attendee and displayed on the attendee computing device. The meeting request 300 includes a set of “Respond” options 76 which the attendee may select in response to the meeting request. In the example shown in FIG. 3, the Respond options 76 include an Accept response 68, Tentative response 70, Decline response 72, and Propose New Time response 74. Meeting request 300 includes a From field 55 indicating the name of the meeting organizer who sent the request, as well as a Required field 56 indicating attendees the meeting request 300 was sent to viewed as being required for the meeting. The meeting request 300 also includes an Optional field 58 indicating any names the meeting request 300 was sent to who are viewed as being optional attendees of the meeting.

The meeting request 300 also includes a variety of text fields 67 containing text entered by the meeting organizer who composed the meeting request 300. For example, the text fields 67 may include a Subject text field 60, Location text field 62, When text field 64, and Description text field 66. The Description text field 66 or other similar multi-line text field typically contains the main body of the text written by the meeting organizer when composing the meeting request.

In the example shown in FIG. 3, the meeting request is a request to participate in a telephone conference call, as opposed to an “in-person” face-to-face meeting. The meeting organizer has included a conference call Dial-in number 69, conference identification number 71, and user ID number 73 in the Description text field 66. In further examples, one or more of the Dial-in number 69, conference identification number 71, and user ID number 73 may be placed in a text field 67 other than the Description text field 66, depending on how the meeting organizer chooses to compose the meeting request. For example, the Dial-in number 69 may appear in the Location text field 62 or Subject text field 60 rather than the Description text field 66. Furthermore, the Dial-in number 69, conference identification number 71, and user ID number 73, while contained in the meeting request, may not be specifically referred to by name or referred to using different or abbreviated names. For example, the meeting organizer may assume that simply by providing a telephone number somewhere in the meeting request, the attendee will recognize that this is the dial-in number for the conference call without the need for it to be so labeled.

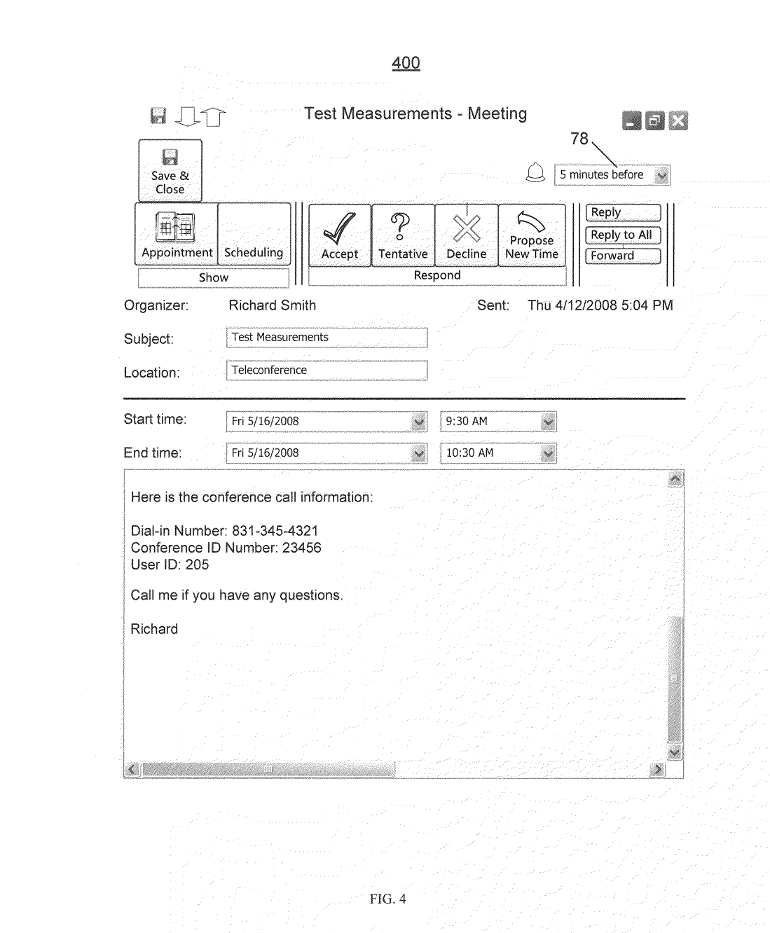

After viewing the opened meeting request 300, the attendee may choose to accept the meeting request using the Accept response 68 command. Alternatively, the attendee may also choose one of the other Respond options 76. If the attendee accepts the meeting request, a calendar event associated with the meeting is placed on the attendee calendar at the meeting date and time. FIG. 4 illustrates an opened calendar event 400 displayed at the attendee device corresponding to the meeting request shown in FIG. 3, where the meeting request has been accepted by an attendee.

Referring to FIG. 4, the opened calendar event 400 contains meeting information transferred from the meeting request 300 shown in FIG. 3. For example, the opened calendar event 400 may include information transferred from the Subject text field 60, Location text field 62, and Description text field 66. Referring to FIG. 4, the opened calendar event 400 includes a Reminder field 78 allowing the attendee to select a time prior to the meeting to be reminded. In the example shown, the attendee will be reminded 5 minutes before the scheduled start time. The contents of the reminder, as discussed below, are dependent on whether the meeting request has been identified as a telephone conference call meeting.

If the attendee accepts the meeting request, the conference call auto-connect application at the attendee device determines whether the meeting request is a request for a telephone conference call meeting. Referring again to FIG. 3, in one example, the text field's 67 containing information input by the organizer is scanned (i.e., processed) to identify whether a dial-in number and conference identification number are contained anywhere in the meeting request. As mentioned previously, since the meeting request may be used for meetings other than conference calls, there may not be data fields specific to dial-in information. Thus, the meeting organizer may put the dial-in information in any of several text fields. The text fields 67 may also be scanned to identify whether a user identification number is contained anywhere in the meeting request. For example, select keywords may be scanned for such as “dial-in”, “meeting number”, or “user id” and numerical strings following such keywords identified. Alternatively, numerical strings may be scanned for and identified as a telephone number if containing the appropriate number of digits or in a standardized telephone number format.

If a dial-in number is recognized, the meeting request is classified as a telephone conference meeting. If recognized, the dial-in number, conference identification number, and/or user identification number are stored in memory at the attendee device for later use by the conference call auto-connect application. Depending on the nature of the conference call, only the dial-in number, both the dial-in number and the conference identification number, or all three of the dial-in number, conference identification number, and user identification number may be present in the meeting request.

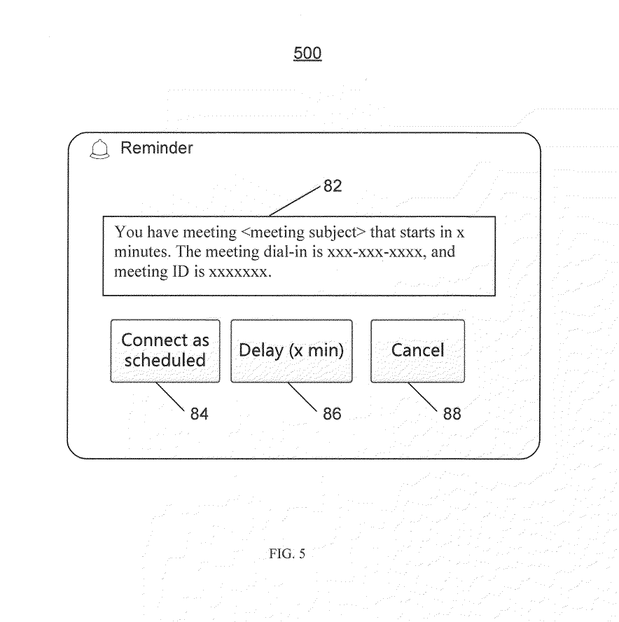

If the attendee has selected to be reminded of the calendar item, at the predetermined reminder time a reminder is displayed on the attendee computing device. Where the received meeting request has been previously identified as a telephone conference call meeting, the reminder consists of a conference call reminder/instruction request prompt. Where the received meeting request has not been previously identified as a telephone conference call, the displayed reminder is a standard meeting reminder as used by the calendaring application. FIG. 5 illustrates a conference call reminder/instruction request prompt 500 in one example. The conference call reminder/instruction request prompt 500 includes an information field 82 informing the attendee of the upcoming conference call, and may include the meeting subject and previously identified dial-in number and meeting identification number. If previously identified, the user identification number may also be displayed. The user identification number may be used to indicate whether the attendee is a designated conference call leader and whether the attendee has the option of connecting to the conference call as the conference call leader. The conference call reminder/instruction request prompt 500 presents several options that the attendee may select. The attendee may select to connect as scheduled to the conference call, delay connection, or cancel the conference call. In the example shown in FIG. 5, the attendee may choose to connect as scheduled 84, delay connection 86 by x minutes, or cancel 88 the conference call.

In one example, the meeting reminder is displayed on multiple attendee computing devices. For example, the meeting reminder is displayed on both the user desktop PC and the user smartphone where the devices have a synchronized calendar. In this example, the device at which the user selects to connect or cancel is the device at which the call to the dial-in number is initiated.

If the attendee chooses to connect to the telephone conference call as originally scheduled 84, at the designated meeting date and time, the conference call auto-connect application automatically calls the dial-in-number.

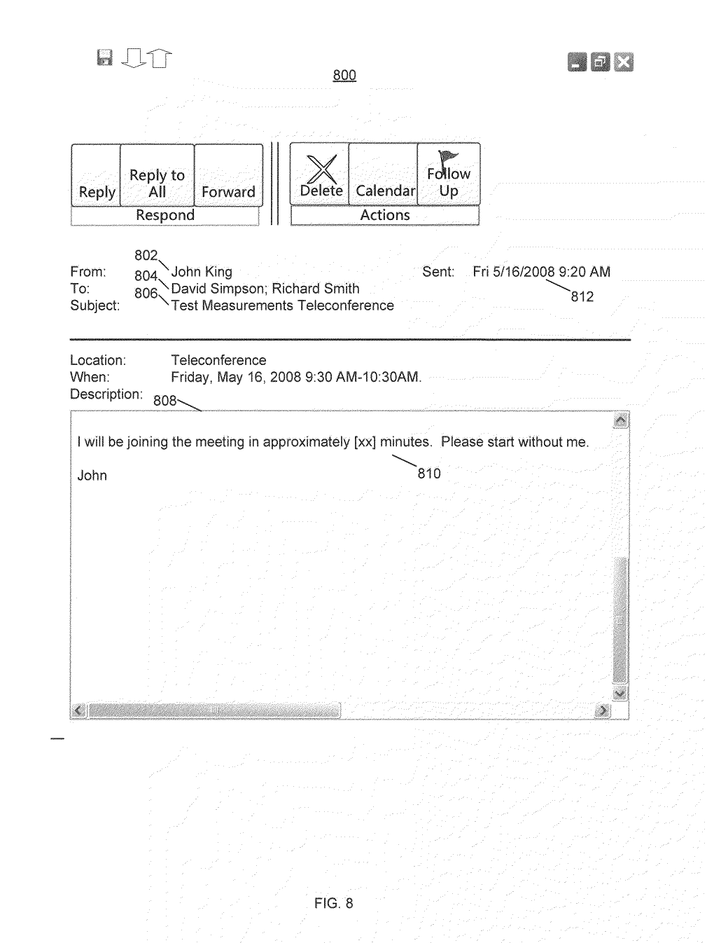

If the attendee chooses to delay connection 86, a status message is broadcast to other meeting attendees. FIG. 8 illustrates a broadcast status message 800 sent to meeting attendees in one example. The broadcast status message 800 includes a From: field 802 indicating the name of the meeting attendee indicating he or she will be delayed in joining the meeting.

The broadcast status message 800 also includes a To: field 804 indicating all meeting attendees to which the status message is being sent. In one example, a status message recipient list is generated and utilized. The list is composed of meeting attendees to which status messages are sent. For example, the status message recipient list may be generated by scanning the contents of the meeting request notification message and extracting attendee identification information, such as the attendee name and/or email address for each meeting attendee. In addition, for each attendee, a SMS contact number may be retrieved from the attendee computing device. For example, the SMS contact number may be a mobile phone number stored in a contacts or similar folder on the attendee computing device.

The broadcast status message 800 also includes a Subject text field 806 and Sent: text field 812. Sent: text field 812 indicates the date and time the broadcast status message was sent. A Description text field 808 or other similar multi-line text field typically contains the main body of the status message. In the example shown in FIG. 8, a pre-selected message 810 is automatically entered into the Description text field 808. In one example, the pre-selected message 810 allows the user to enter an approximate time indicating when the attendee will be able to join the meeting. In another example, the pre-selected message 810 simply informs other meeting attendees the user will be delayed and will call in when available. In one example, the broadcast status message 800 is automatically generated and sent to all meeting attendees responsive to the user selecting to delay connection 86, without the need for the user to ever view message 800. In further examples, the status message may be an SMS message. Where the status message is an SMS message, it may include only a brief pre-selected message informing other meeting attendees of a delay. In this manner, selection of the delay command allows the user to broadcast the status message to all other meeting attendees with a single action (i.e., “one-click”).

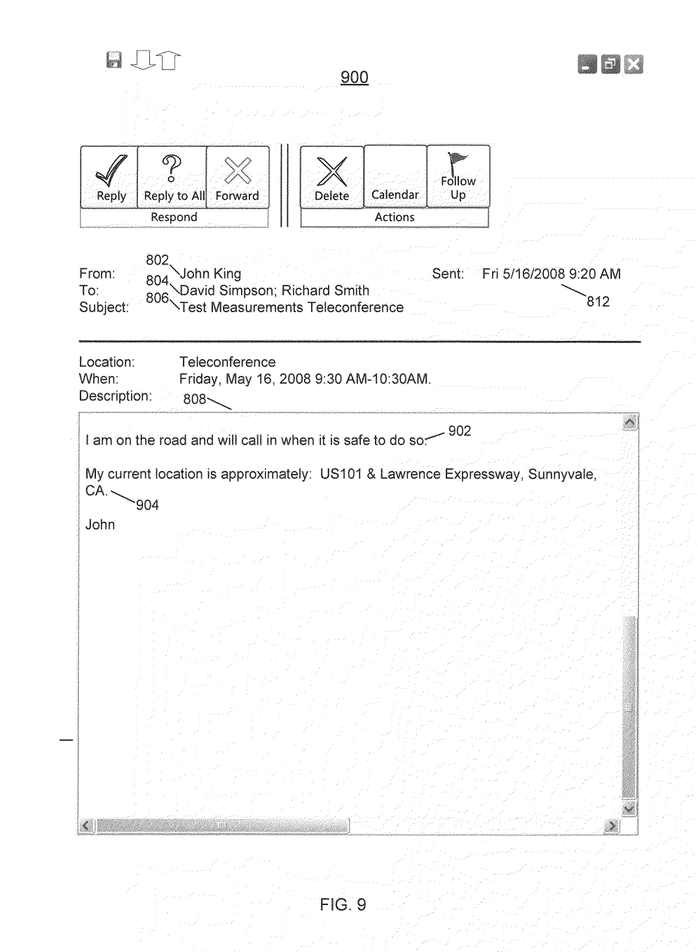

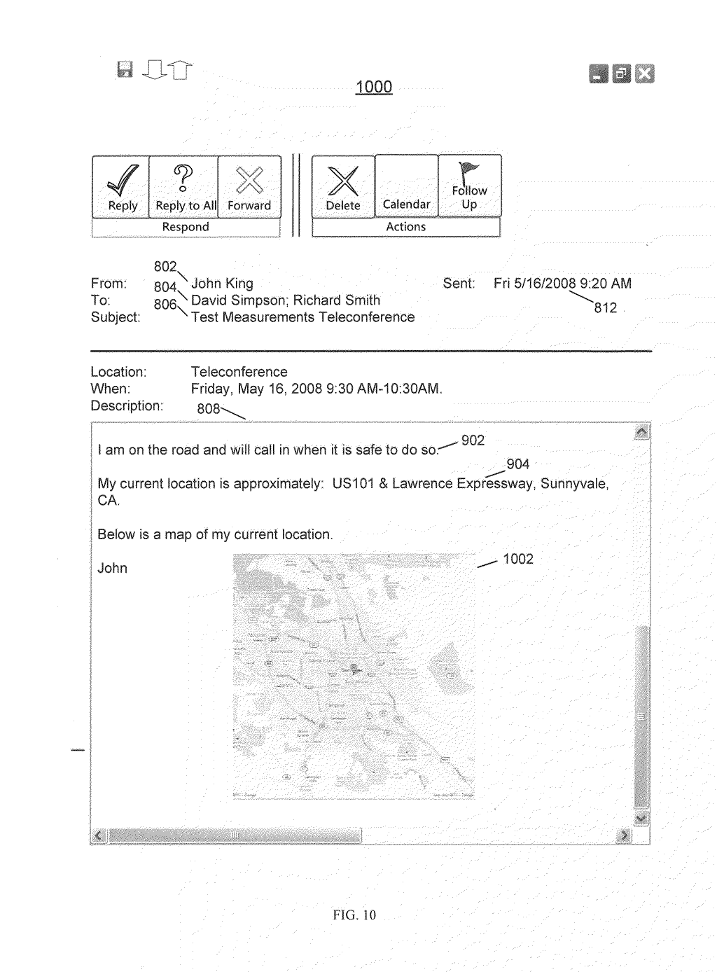

FIG. 9 illustrates a broadcast status message 900 sent to meeting attendees having attendee location information in one example. Broadcast status message 900 is similar to broadcast message 800 except that in addition to a pre-selected message 902, it includes location information 904 associated with the meeting attendee. In the example shown in FIG. 9, the location information 904 is a textual description describing the user's current location. In the example shown in FIG. 10, a broadcast status message 1000 also includes an appended map 1002 indicating the user's current location.

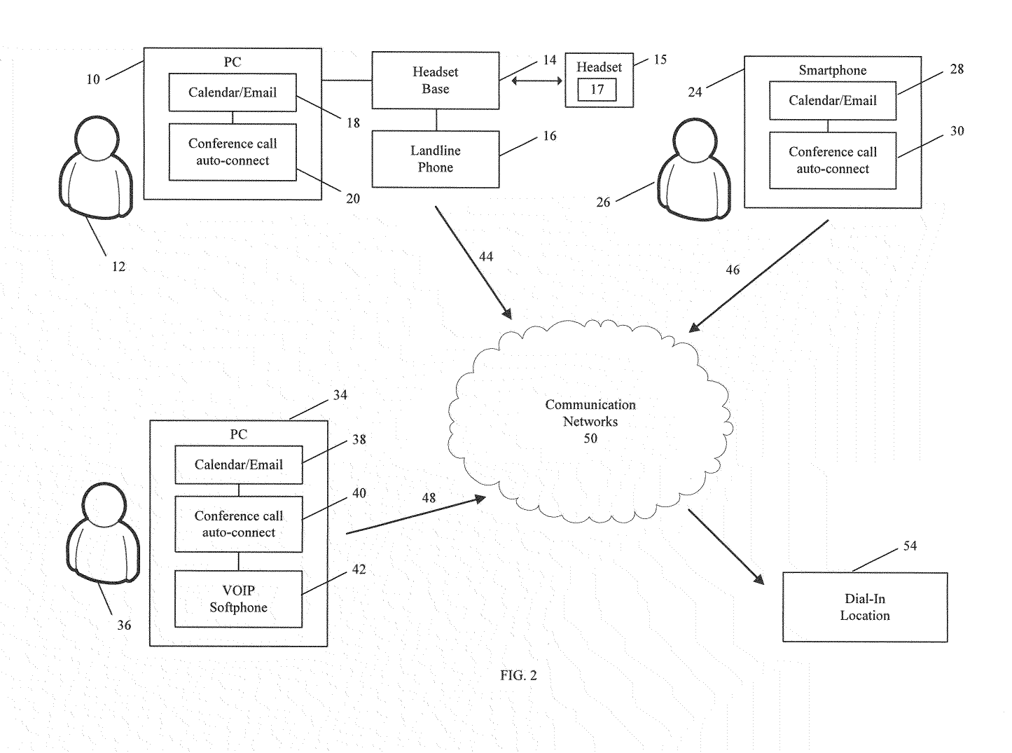

FIG. 2 illustrates auto-dialing into a dial-in location 54 using several types of attendee computing devices at the delayed meeting time or scheduled meeting date and time. In FIG. 2, attendees 12, 26, and 36 have accepted meeting requests 8, 22, and 32 respectively, sent by meeting organizer 2 shown in FIG. 1.

Referring to FIG. 2, conference call auto-connect application 20 retrieves the previously stored dial-in number from memory at personal computer 10 and initiates a call 44 to dial-in location 54 via communication networks 50. In one example, call 44 is a landline call placed over a public switched telephone network.

In one example, the conference call auto-connect application 20 launches only when it is capable of initiating dialing through landline telephone 16. For example, conference call auto-connect application 20 may launch only when a headset 15 associated with the headset base 14 is active and/or donned (worn) by the attendee. In other examples, the conference call auto-connect application 20 may continuously run.

In one example, the headset 15 includes a don/doff detector 17 which detects whether the headset 15 is donned or doffed. Such detectors may include the use of motion or capacitance sensors. Further discussion regarding the use of sensors or detectors and determination circuits to detect a donned or doffed state can be found in the commonly assigned and co-pending U.S. patent application entitled “Donned and Doffed Headset State Detection” (Attorney Docket No.: 01-7308), which was filed on Oct. 2, 2006, and which is hereby incorporated into this disclosure by reference for all purposes. If it is detected that the headset 15 is donned by the attendee, calls are automatically initiated at the meeting date and time without need for attendee confirmation using the reminder prompt.

Conference call auto-connect application 20 transfers the retrieved dial-in number to headset base station 14 and landline telephone 16, which initiate call 44. Upon connection with the dial-in location 54, conference call auto-connect application 20 retrieves the conference identification number and/or user identification number from memory at personal computer 10 and transmits them to dial-in location 54 to connect (i.e., gain admission or join) to the conference call. Conference call auto-connect application 20 may also retrieve and transmit a pre-stored voice signature to the dial-in location 54 to announce attendee 12.

Referring again to FIG. 2, a conference call auto-connect application 40 retrieves the previously stored dial-in number from memory at personal computer 34 and initiates a call 48 to dial-in location 54 via communication networks 50. In one example, call 48 is a VoIP phone call placed over an IP communications network such as the Internet. Conference call auto-connect application 40 transfers the retrieved dial-in number to a VoIP softphone application 42 operating on personal computer 34, which initiates call 48. Upon connection with the dial-in location 54, conference call auto-connect application 40 retrieves the conference identification number and/or user identification number from memory at personal computer 34 and transmits them to dial-in location 54 using VoIP softphone application 42 to connect (i.e., gain admission or join) to the conference call. Conference call auto-connect application 40 may also retrieve and transmit a pre-stored voice signature to the dial-in location 54 to announce attendee 36.

Communication networks 50 may be any combination of communication networks capable Of carrying voice data, including a PSTN, a wireless telecommunication provider network, the Internet, a Local Area Network (LAN), Wide Area Network (WAN), or Internet Protocol (IP) network implementing VoIP. Dial-in location 54 may, for example, be a telephone conference bridge or other service center.

Similarly, a conference call auto-connect application 30 retrieves the previously stored dial-in number from memory at smartphone 24 and initiates a call 46 to dial-in location 54 via communication networks 50. In one example, call 46 is a mobile phone call placed over a wireless communications network. Conference call auto-connect application 30 transfers the retrieved dial-in number to an outgoing call controller of smartphone 24, which initiates call 46. Upon connection with the dial-in location 54, conference call auto-connect application 30 retrieves the conference identification number and/or user identification number from memory at smartphone 24 and transmits them to dial-in location 54 to connect (i.e., gain admission or join) to the conference call. Conference call auto-connect application 30 may also retrieve and transmit a pre-stored voice signature to the dial-in location 54 to announce attendee 26.

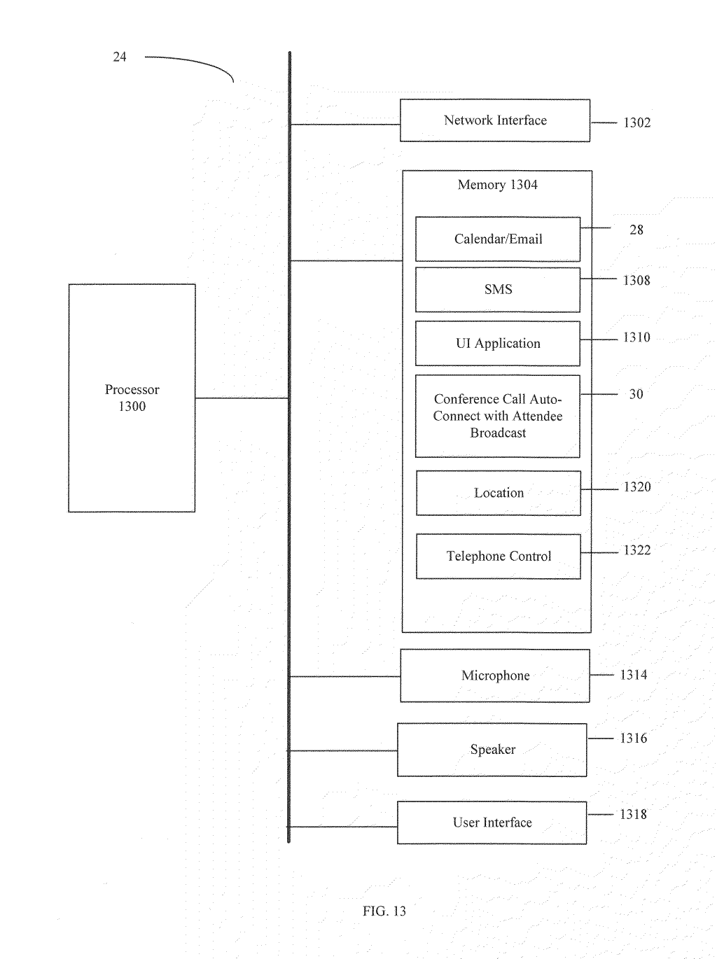

FIG. 13 illustrates a simplified block diagram of a smartphone 24 in one example implementation. Smartphone 24 includes a processor 1300 operably coupled to a network interface 1302, memory 1304, microphone 1314, speaker 1316, and a user interface 1318. In one example, network interface 1302 is a wireless communications transceiver and accompanying antenna used to connect smartphone 24 to a cellular communications network or a local area network.

Processor 1300 allows for processing data, including managing dial-in information, status messages, and calendaring information. Processor 1300 may include a variety of processors (e.g., digital signal processors), with conventional CPUs being applicable. Memory 1304 may include a variety of memories, and in one example includes SDRAM, ROM, flash memory, or a combination thereof. Memory 1304 may further include separate memory structures or a single integrated memory structure. In one example, memory 1304 may be used to store passwords, network and telecommunications programs, and/or an operating system (OS).

Memory 1304 stores a calendar/email application 28 executed by processor 1300 to receive meeting invitations, display reminders, and store call-in times as described herein. Memory 1304 also stores a telephone control application 1322 executed by processor 1300 to initiate calls. Memory 1304 also includes a SMS application 1308 for sending and receiving SMS messages, location application 1320 for determining a user location using network data or GPS, and a user interface application 1310. User interface 1310 allows for manual communication between the user and the smartphone 24, and includes an audio and/or visual interface.

Memory 1304 further stores a conference call auto-connect application 30 with attendee broadcast performing functions described herein. The call auto-connect application 30 is synchronized with the calendar/email application 28 on the smartphone to track telephone conference call events stored on the smart phone calendar/email application 28.

In one example implementation, the call auto-connect application 30 maintains a list of upcoming conference calls and associated information with each upcoming conference call in a conference call record. For each conference call record, the scheduled time of the meeting is stored as well as any other information in the calendar, including identification of the meeting attendees. Any changes or deletions to the user calendar, including meeting time or attendees, are automatically tracked by the call auto-connect application 30 and updated in the conference call record.

A list of attendees may also be stored in the conference call record, as well as attendee contact information such as e-mail address or SMS contact information. In one example, the list of attendees is extracted from the user smartphone. The attendee contact information may be extracted from a contacts application on the user smartphone or from the meeting invitation. In a further example, the list of attendees is generated and updated by scanning data stored at an exchange server, such as a Microsoft exchange server in a Microsoft Outlook implementation. In one example, the list of meeting attendees may be generated and stored at the call auto-connect application 30 prior to user selection to connect to the conference call at the scheduled time or user selection to delay connection. In one example, the list of attendees is generated by extracting from the meeting invitation the attendee names to which the meeting invitation was sent. Any changes to the list of attendees are monitored by scanning and extracting such information from subsequent emails and/or changes to the user calendar.

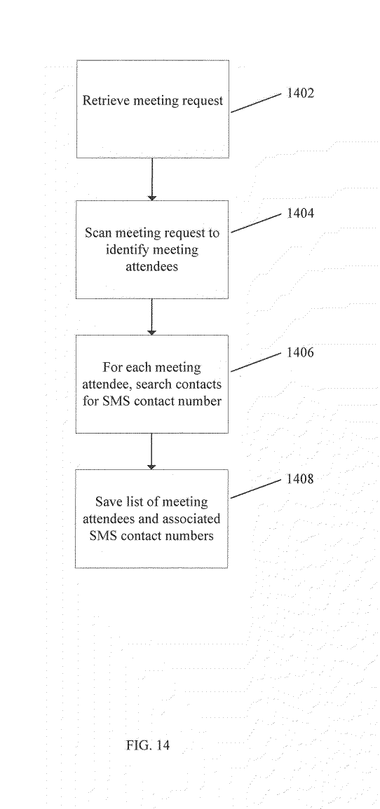

FIG. 14 is a flow diagram illustrating generating a list of meeting attendees to which status messages are broadcast in one example. At block 1402, a meeting request is retrieved. At block 1404, the meeting request is scanned to identify meeting attendees. At block 1406, for each meeting attendee, a contacts folder is searched for a SMS contact number. At block 1408, a list of meeting attendees and associated SMS contact numbers are saved.

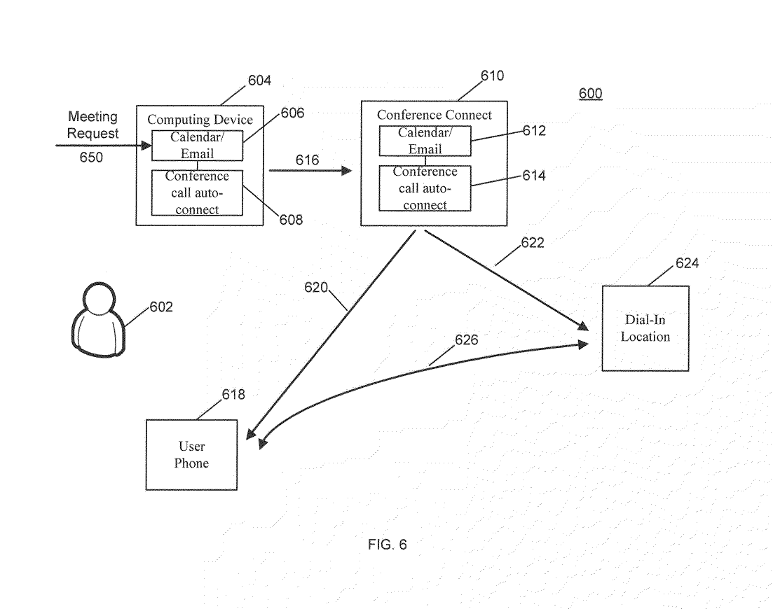

FIG. 6 illustrates a system 600 for auto-dialing into a dial-in location in a further example. System 600 includes a computing device 604 executing a calendar/email application 606. The system 600 also includes a conference call connect server 610 executing a calendar/email application 612 and conference call auto-connect application 614. In one example, computing device 604 includes a conference call auto-connect application 608 performing functions described herein. In a further example, computing device 604 does not have conference call auto-connect application 608, and meeting requests received at computing device 604 are forwarded to conference call connect server 610 for processing. In FIG. 6, an attendee 602 receives a meeting request 650 sent by a meeting organizer. Upon acceptance of the meeting request 650 by attendee 602, conference call auto-connect application 608 processes the meeting request to identify whether it is a telephone conference call meeting. If yes, then calendar/email application 606 automatically forwards the meeting request to calendar/email application 612 at the conference call connect server 610 using a communication link 616. At this time, the conference call auto-connect application 608 may also prompt the attendee 602 to enter a call-back number corresponding to a telephone the attendee 602 would like to use for the telephone conference call. Since most individuals have several telephony devices available to them, to make and receive calls, requesting the attendee enter a call back number allows the attendee to select the desired telephony device with which to participate in the conference call. For example, if the attendee has knowledge that he will be out of the office at the time of the call, he may choose to enter his mobile phone number or home landline telephone number.

The call-back number is sent to conference call connect server 610 for storage in memory. The calendar/email application 612 places a calendar event corresponding to the accepted meeting request on the calendar at the meeting date and time. The conference call auto-connect application 614 scans the text fields of the meeting request to identify the dial-in number, conference identification number, and/or user identification number and stores them in memory at the conference call connect server 610. Alternatively, the conference call auto-connect application 608 at the computing device 604 scans the text fields of the meeting request to identify the dial-in number, conference identification number, and/or user identification number, and sends this data to conference call connect server 610 via communication link 616 for storage in memory at the conference call connect server 610

The attendee 602 receives a conference call reminder/instruction request which prompts the attendee to connect to, delay connection, or cancel the telephone conference call. The attendee 602 must confirm his desire to connect or delay connection as a pre-requisite for the conference call auto-connect application 614 to call the dial-in number. At this time, the attendee 602 may be prompted to enter a call-back number to be used for the telephone conference call if not provided previously by the attendee 602, which is then sent to conference call connect server 610. Where the attendee 602 selects to delay connection, the attendee 602 may be prompted to enter a delayed new call-in time, or the attendee 602 may also be prompted to indicate a desire to be reminded again after a selected time (i.e., a reminder snooze) whether the attendee 602 wishes to connect, delay, or cancel the delayed call-in time.

The conference call auto-connect application 614 retrieves the previously stored dial-in number from memory at conference call connect server 610 and initiates a call 622 to dial-in location 624 at the scheduled time or delayed call-in time. Upon connection with the dial-in location 624, conference call auto-connect application 614 retrieves the conference identification number and/or user identification number from memory at conference call connect server 610 and transmits them to dial-in location 624 to connect (i.e., gain admission or join) to the conference call. Upon connection with the dial-in location 624, the conference call auto-connect application 614 retrieves the previously stored attendee call-back number from memory at conference call connect server 610 and initiates a call 620 to an attendee phone 618. Attendee phone 618 may, for example, be the attendee's mobile phone, landline phone, or VoIP phone depending upon the call-back number provided by the attendee. In this manner, the attendee 602 may participate in the conference call regardless of his location. Advantageously, the attendee phone 618 need not run any additional conference call software for the auto-connect process to occur.

Upon connection with attendee phone 618, the conference call connect server 610 links call 620 with call 622 to form a direct link 626 between attendee phone 618 and dial-in location 624. Upon formation of direct link 626, conference call auto-connect application 614 may retrieve and transmit a pre-stored voice signature to the dial-in location 624 to announce attendee 602.

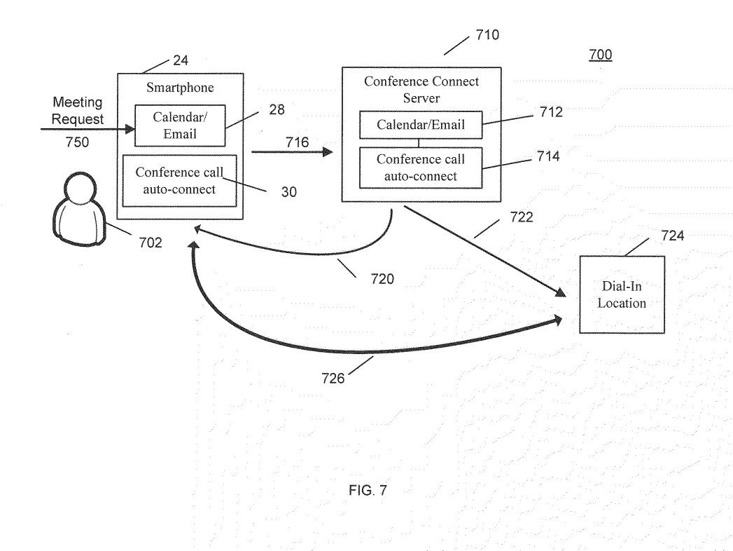

FIG. 7 illustrates a system 700 for auto-dialing into a dial-in location in a further example. System 700 is similar to system 600 except that computing device 604 and user phone 618 have been integrated into a smartphone 24. System 700 includes a smartphone 24 executing a calendar/email application 28. The system 700 also includes a conference call connect server 710 executing a calendar/email application 712 and conference call auto-connect application 714. In one example, smartphone 24 includes a conference call auto-connect application 30 performing functions described herein. In a further example, smartphone 24 does not have conference call auto-connect application 30, and meeting requests received at smartphone 24 are forwarded to conference call connect server 710 for processing.

In FIG. 7, an attendee 702 receives a meeting request 750 sent by a meeting organizer. Upon acceptance of the meeting request 750 by attendee 702, conference call auto-connect application 30 processes the meeting request to identify whether it is a telephone conference call meeting. If yes, then calendar/email application 28 automatically forwards the meeting request to calendar/email application 712 at the conference call connect server 710 using a communication link 716. At this time, the conference call auto-connect application 30 may also prompt the attendee 702 to enter a call-back number corresponding to a telephone the attendee 702 would like to use for the telephone conference call. Since most individuals have several telephony devices available to them to make and receive calls, requesting the attendee enter a call back number allows the attendee to select the desired telephony device with which to participate in the conference call. For example, if the attendee has knowledge that he will be out of the office at the time of the call, he may choose to enter his mobile phone number or home landline telephone number. In this example, the attendee 702 will enter the phone number for smartphone 24 as the call-back number.

The call-back number is sent to conference call connect-server 710 for storage in memory. The calendar/email application 712 places a calendar event corresponding to the accepted meeting request on the calendar at the meeting date and time. The conference call auto-connect application 714 scans the text fields of the meeting request to identify the dial-in number, conference identification number, and/or user identification number and stores them in memory at the conference call connect server 710. Alternatively, the conference call auto-connect application 30 at the smartphone 24 scans the text fields of the meeting request to identify the dial-in number, conference identification number, and/or user identification number, and sends this data to conference call connect server 710 via communication link 716 for storage in memory at the conference call connect server 710

The attendee 702 receives a conference call reminder/instruction request at smartphone 24 which prompts the attendee to connect to, delay connection, or cancel the telephone conference call. The attendee 702 must confirm his desire to connect or delay connection as a pre-requisite for the conference call auto-connect application 714 to call the dial-in number. Where the attendee 702 selects to delay connection, the attendee 702 may be prompted to enter a delayed new call-in time, or the attendee 702 may also be prompted to indicate a desire to be reminded again after a selected time (i.e., a reminder snooze) whether the attendee 702 wishes to connect, delay, or cancel the delayed call-in time.

The conference call auto-connect application 714 retrieves the previously stored dial-in number from memory at conference call connect server 710 and initiates a call 722 to dial-in location 724 at the scheduled or delayed call-in time. Upon connection with the dial-in location 724, conference call auto-connect application 714 retrieves the conference identification number and/or user identification number from memory at conference call connect server 710 and transmits them to dial-in location 724 to connect (i.e., gain admission or join) to the conference call. Upon connection with the dial-in location 724, the conference call auto-connect application 714 retrieves the previously stored attendee smartphone 24 call-back number from memory at conference call connect server 710 and initiates a call 720 to smartphone 24. In this manner, the attendee 702 may participate in the conference call regardless of his location.

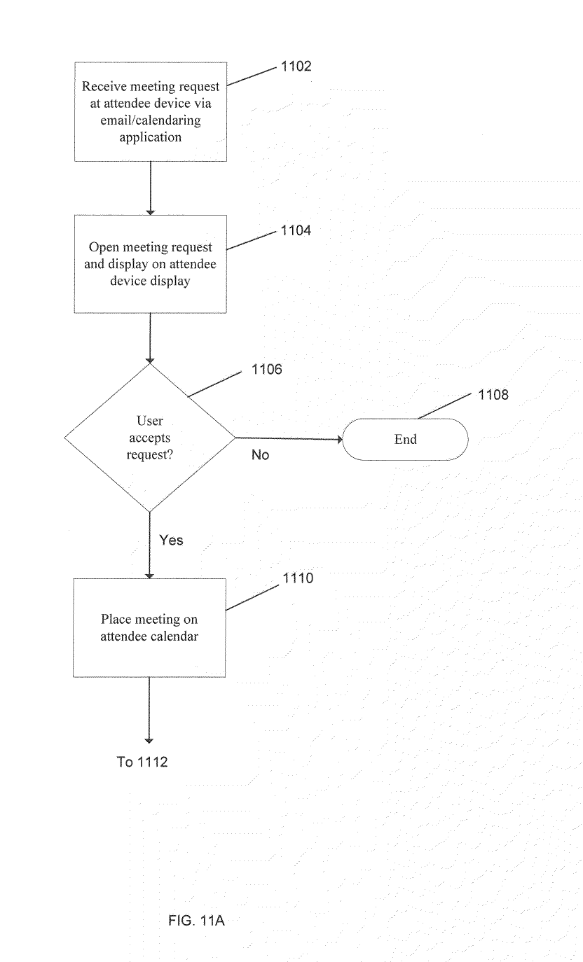

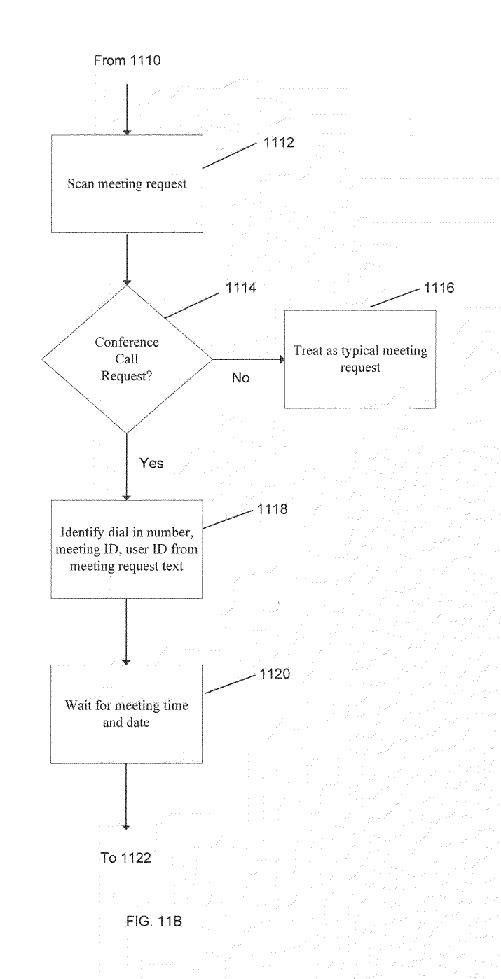

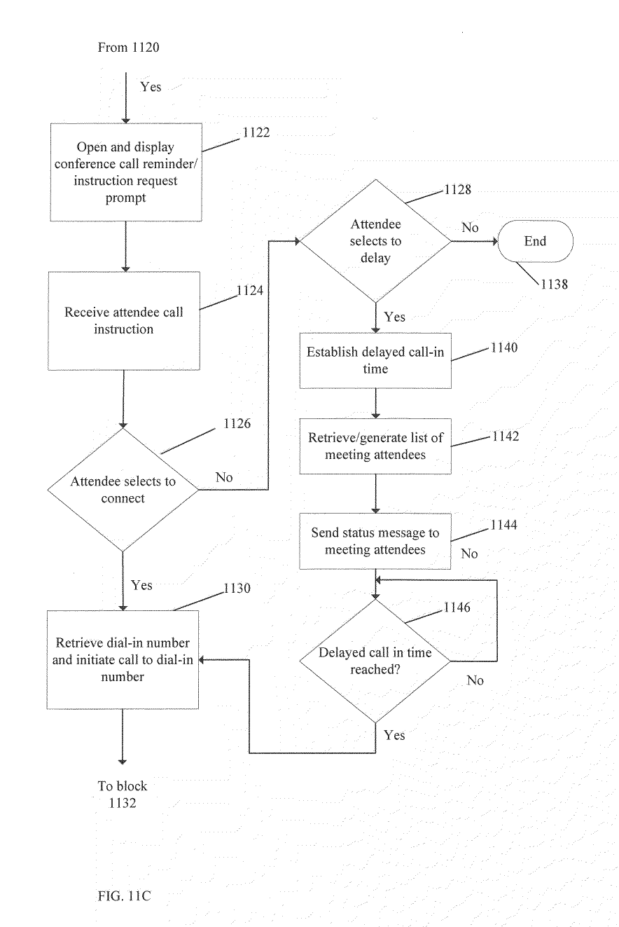

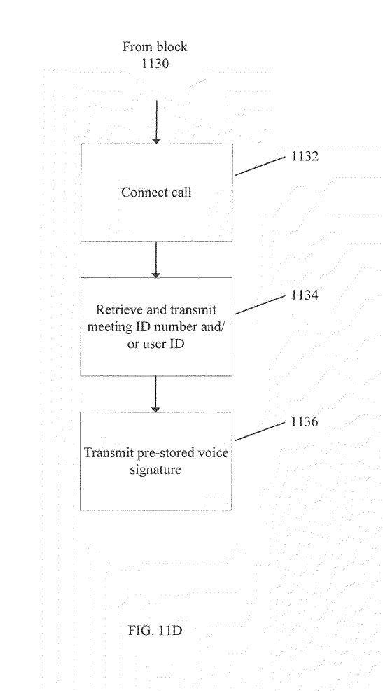

FIGS. 11A-11D are a flow diagram illustrating auto-dialing and connection into conference calls in one example of the invention. At block 1102, an attendee receives a meeting request at an attendee device via an email/calendaring application executed on the attendee device. For example, the attendee computing device is a personal computer, smartphone, or any other computing device capable of connection to a communications network.

In one example, the meeting request is received via email. At block 1104, upon opening by the attendee, the meeting request is opened and the meeting request is displayed on the attendee computing device. The meeting request includes a proposed date and time, and a prompt for the attendee to accept or reject the meeting request. At decision block 1106, an accept meeting instruction or a reject meeting instruction is then received from the attendee. If the attendee does not accept the meeting request (i.e., responds with a reject meeting instruction), at block 1108 the conference call connect process ends.

If the attendee accepts the meeting request (i.e., responds with an accept meeting instruction), at block 1110 the meeting request is placed on the attendee calendar at the proposed date and time as a calendar item. At block 1112, the meeting request text is scanned. At decision block 1114, it is determined whether the meeting request is a request for a telephone conference call. For example, if a conference call dial-in number is identified at block 1112, the meeting request is classified as a telephone conference call. If no at decision block 1114, at block 1116 the meeting request is classified and treated as an in-person meeting and the conference call connect process ends.

If yes at decision block 1114, the conference call dial-in number, conference call meeting identification number, and user identification number are identified from the meeting request at block 1118. Depending upon the nature of the conference call and the specific attendee receiving the meeting request, a user identification number may or may not be included in the meeting request. In one example, the identified items are stored in a memory at the computing device.

At block 1120, the calendar/email application waits for the calendar item scheduled date and time. At block 1122, a meeting reminder is opened and displayed on the attendee computing device at the proposed date and time or a predetermined period prior to the proposed date and time. The meeting reminder serves to both remind the attendee of the upcoming telephone conference call and prompt the attendee to enter a call instruction confirming or cancelling his desire to participate in the telephone conference call. At block 1124, a telephone conference call, instruction is received from the attendee.

At decision block 1126, it is determined whether the attendee has selected to connect to the telephone conference call. If yes at decision block 1126, the process proceeds to block 1130. If no at decision block 1126, at decision block 1128 is determined whether the attendee selects to delay call-in. If no at decision block 1128, the conference call connect process ends. If yes, at decision block 1128, at block 1140 a delayed call-in time is established. At block 1142, a list of meeting attendees is retrieved or generated. At block 1144, a status message is sent to each meeting attendee on the list of meeting attendees. At decision block 1146, is determined whether the delayed call-in time has been reached. If no at decision block 1146, the process waits. If yes at decision block 1146, the process proceeds to block 1130.

At block 1130, the dial-in number is retrieved from memory at the scheduled date and time or the delayed call-in time and automatically called. Depending upon the attendee computing device, automatically calling the dial-in number may involve initiating a call over an Internet Protocol network, a mobile cellular network, or a public switched telephone network (PSTN). At block 1132, a network connection is established with a remote device corresponding to the dial-in location to connect the call. At block 1134, the conference call meeting identification number is transmitted over the network connection to the remote device. If available, the user identification number is also automatically transmitted over the network connection. In one example, at block 1136, a pre-stored voice signature for the attendee is transmitted over the network connection to the remote device to announce the presence of the attendee to the other conference call participants.

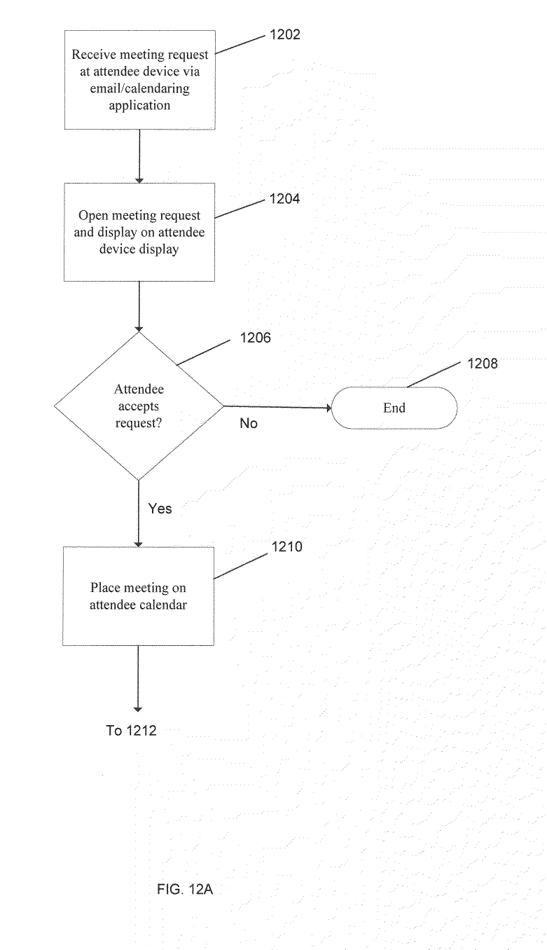

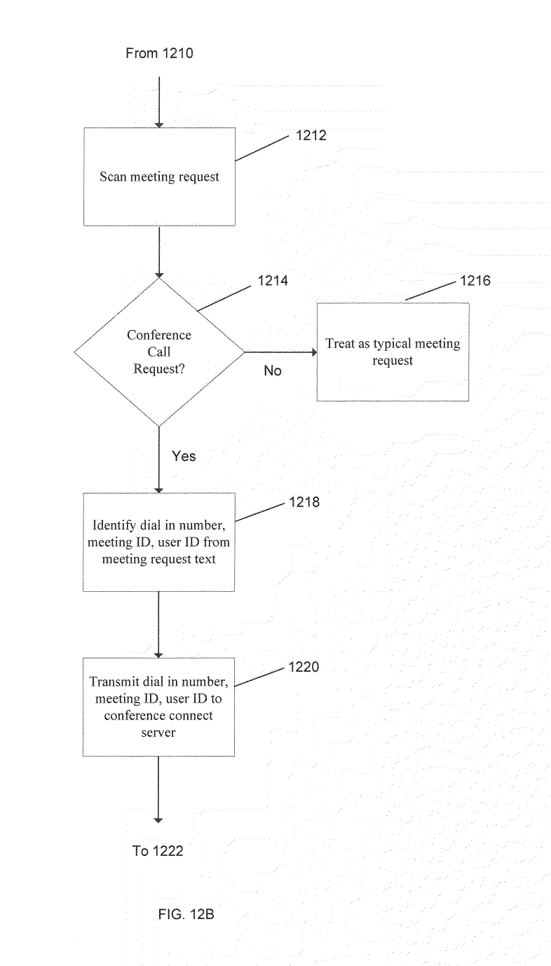

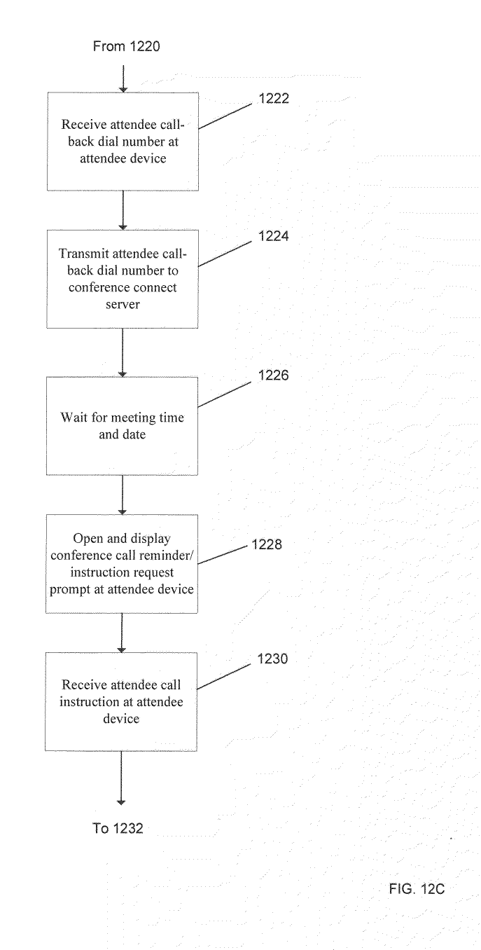

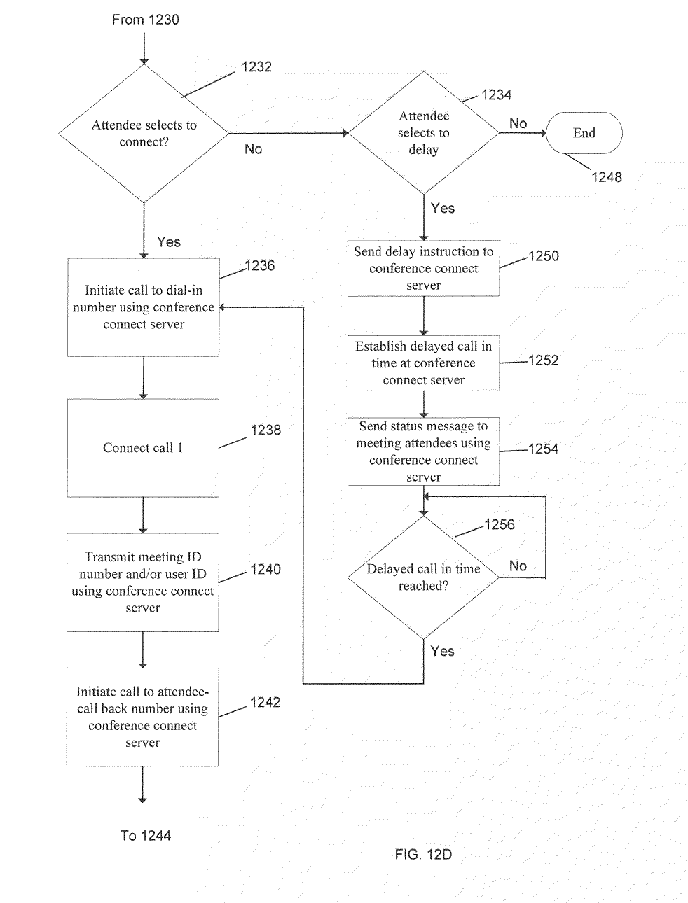

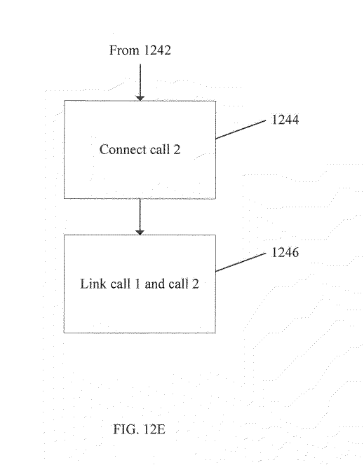

FIGS. 12A-12D are a flow diagram illustrating auto-dialing and connection into conference calls in a further example of the invention. For example, the process illustrated may be implemented by system 600 shown in FIG. 6 or system 700 shown in FIG. 7. At block 1202, an attendee receives a meeting request at an attendee device via an email/calendaring application executed on the attendee device. For example, the attendee computing device is a personal computer, smartphone, or any other computing device capable of connection to a communications network. In one example, the meeting request is received via email. In further examples, the meeting request may be in the form of other types of electronic messages, such as SMS messages. At block 1204, upon opening by the attendee, the meeting request is opened and the meeting request is displayed on the attendee computing device. The meeting request includes a proposed date and time, and a prompt for the attendee to accept or reject the meeting request. At decision block 1206, an accept meeting instruction or a reject meeting instruction is then received from the attendee. If the attendee does not accept the meeting request (i.e., responds with a reject meeting instruction), at block 1208 the conference call connect process ends.

If the attendee accepts the meeting request (i.e., responds with an accept meeting instruction), at block 1210 the meeting request is placed on the attendee calendar at the proposed date and time as a calendar item. At block 1212, the meeting request text is scanned. At decision block 1214, it is determined whether the meeting request is a request for a telephone conference call. For example, if a conference call dial-in number is identified at block 1212, the meeting request is classified as a telephone conference call. If no at decision block 1214, at block 1216 the meeting request is classified and treated as an in-person meeting and the conference call connect process ends.

If yes at decision block 1214, the conference call dial-in number, conference call meeting identification number, and user identification number are identified from the meeting request at block 1218. Depending upon the nature of the conference call and the specific attendee receiving the meeting request, a user identification number may or may not be included in the meeting request.

At block 1220, the conference call dial-in number and the conference call meeting identification number are transmitted to a remote conference call connect server for storage. If located, the user identification number is also transmitted. At block 1222, an attendee call-back number input at the attendee computing device by the attendee is received. Alternatively, the attendee call-back number is received at block 1230 below when the attendee call instruction is received. At block 1224, the attendee call-back number is transmitted to the remote conference call connect server for storage in the memory of the conference call connect server.

In one example, the meeting-request received at the attendee computing device is forwarded to the conference call connect server and placed on a calendaring application at the conference call connect server at the proposed date and time. Alternatively, only the telephone conference date and time data is sent to the conference call connect server.

At block 1226, the calendar/email application waits for the calendar item scheduled date and time. At block 1228, a meeting reminder is opened and displayed on the attendee computing device at the proposed date and time or a predetermined period prior to the proposed date and time. The meeting reminder serves to both remind the attendee of the upcoming telephone conference call and prompt the attendee to enter a call instruction confirming or cancelling his desire to participate in the telephone conference call. At block 1230, a telephone conference call instruction is received from the attendee. This instruction is sent to the remote conference call connect server.

At decision block 1232, it is determined whether the attendee has selected to connect to the telephone conference call. If yes at decision block 1232, the process proceeds to block 1236. If no at decision block 1232, at decision block 1234, it is determined whether the attendee selects to delay call-in. If no at decision block 1234, the process ends at block 1248. If yes at decision block 1234, at block 1250 a delay instruction is sent to the conference connect server. At block 1252 a delayed call-in time is established at the conference connect server. At block 1254, a status message is sent to all meeting attendees using the conference connect server. At decision block 1256, it is determined whether the delayed call-in time has been reached. If no at decision block 1256, the process waits. If yes at decision block 1256, the process proceeds to block 1236.

At block 1236, the dial-in number is retrieved from memory at the scheduled date and time or the delayed call-in time and automatically called by the conference call connect server. At block 1238, a network connection is established with a remote device corresponding to the dial-in location to connect the first call. At block 1240, the conference call meeting identification number is transmitted over the network connection to the remote dial-in location by the conference call connect server. If available, the user identification number is also automatically transmitted over the network connection.

At block 1242, the attendee call back number is retrieved from memory at the scheduled date and time and automatically called by the conference call connect server. At block 1244, a network connection is established with the attendee device corresponding to the call-back location to connect the second call made by the conference call connect server. Advantageously, the attendee device may be a mobile phone, landline phone, or VoIP phone. At block 1246, the conference call connect server links the first call and the second call so that the attendee device is linked to the dial-in location, enabling the attendee to participate in the conference call. In a further example, the attendee call back number is called first, and the dial-in number called second by the conference call connect server.

In one example, a pre-stored voice signature for the attendee is transmitted by the conference call connect server over the first network connection to the remote device to announce the presence of the attendee to the other conference call participants. This may occur prior to or immediately following linking the first call and the second call.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: the type of computing devices used by meeting attendees; the type of communication network used by the telephones; standards to perform the VoIP call setup, signaling, and control; user interface input mechanisms to control conference or hookswitch operation at the headset. For example, the communications network used may be a PSTN, a public or private data network, wireline or wireless network, or the Internet. Reference to the term “PC” refers to any type of computing device, including tablet type devices. Furthermore, the functionality associated with any blocks described above may be centralized or distributed. It is also understood that one or more blocks of the headset may be performed by hardware, firmware or software, or some combinations thereof. Such modifications and changes do not depart from the true spirit and scope of the present invention that is set forth in the following claims.

Those skilled in the art will appreciate that the reference to the terms “VoIP” and “VoIP telephone” are used in the generic sense to include any “voice-over-packet” technique or device, without limitation to a specific standard.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A method for dialing into a conference call comprising:
receiving at an attendee computing device a meeting request notification message comprising a meeting request, wherein the meeting request includes a proposed date and time;
opening the meeting request notification message and displaying the meeting request on the attendee computing device;
receiving an accept meeting instruction or a reject meeting instruction;
scanning a contents of the meeting request notification message to identify a conference call dial-in number and a conference call meeting identification number responsive to receiving the accept meeting instruction;
storing the conference call dial-in number and the conference call meeting identification number in a memory at the attendee computing device;
displaying a meeting reminder on the attendee computing device at the proposed date and time or a predetermined period prior to the proposed date and time;
receiving a conference call confirmation instruction, a delay instruction, or a cancellation instruction;
responsive to receiving the delay instruction, establishing a delayed call-in time and sending a status message to each meeting attendee;
automatically calling the conference call dial-in number at the delayed call-in time; and
transmitting the conference call meeting identification number over.

2. The method of claim 1, further comprising appending a user location information to the status message.

3. The method of claim 2, wherein the user location information is a location map indicating a present location of the user.

4. The method of claim 1, further comprising generating a status message recipient list comprising meeting attendees to which status messages are sent.

5. The method of claim 4, wherein generating a status message recipient list comprises scanning a contents of the meeting request notification message and extracting attendee identification information for each meeting attendee.

6. The method of claim 5, further comprising extracting a SMS contact number from the attendee computing device for each meeting attendee.

7. The method of claim 1, wherein the status message is an email or SMS message.

8. The method of claim 1, further comprising scanning a contents of the meeting request notification message to identify a user identification number and automatically transmitting the user identification number over a network connection.

9. The method of claim 1, wherein the attendee computing device is a personal computer or a smartphone.

10. The method of claim 1, wherein automatically calling the conference call dial-in number comprises automatically initiating a call over an Internet Protocol network, a mobile cellular network, or a public switched telephone network (PSTN).

11. A computer readable storage medium storing instructions that when executed by a computer cause the computer to perform a method for dialing into a conference call comprising:
receiving at an attendee computing device a meeting request notification message comprising a meeting request, wherein the meeting request includes a proposed date and time;
opening the meeting request notification message and displaying the meeting request on the attendee computing device;
receiving an accept meeting instruction or a reject meeting instruction;
scanning a contents of the meeting request notification message to identify a conference call dial-in number and a conference call meeting identification number responsive to receiving the accept meeting instruction;
storing the conference call dial-in number and the conference call meeting identification number in a memory at the attendee computing device;
displaying a meeting reminder on the attendee computing device at the proposed date and time or a predetermined period prior to the proposed date and time;
receiving a conference call confirmation instruction, a delay instruction, or a cancellation instruction;
responsive to receiving the delay instruction, establishing a delayed call-in time and sending a status message to each meeting attendee;
automatically calling the conference call dial-in number at the delayed call-in time; and
transmitting the conference call meeting identification number.

12. The computer readable storage medium of claim 11, further comprising appending a user location information to the status message.

13. The computer readable storage medium of claim 12, wherein the user location information is a location map.

14. The computer readable storage medium of claim 11, further comprising generating a status message recipient list comprising meeting attendees to which status messages are sent.

15. The computer readable storage medium of claim 11, wherein the status message is an email or SMS message.

16. The computer readable storage medium of claim 11, further comprising extracting an SMS contact number from the attendee computing device for each meeting attendee and sending a status message to each meeting attendee comprises sending an SMS message utilizing an extracted SMS contact number.

17. The computer readable storage medium of claim 11, the method further comprising scanning the contents of the meeting request notification message to identify a user identification number and automatically transmitting the user identification number over a network connection.

18. The computer readable storage medium of claim 11, wherein the attendee computing device is a personal computer or a smartphone.

19. The computer readable storage medium of claim 11, wherein automatically calling the conference call dial-in number comprises automatically initiating a call over an Internet Protocol network, a mobile cellular network, or a public switched telephone network.

20. A method for dialing into a conference call comprising:
scanning a contents of a meeting request notification message to identify a conference call dial-in number and a conference call meeting identification number;
transmitting the conference call dial-in number and the conference call meeting identification number to a first remote device for storage in a memory of the first remote device;
receiving an attendee call-back number input at an attendee computing device;
transmitting the attendee call-back number to the first remote device for storage in the memory of the first remote device;
displaying a meeting reminder on the attendee computing device at a proposed meeting date and time or a predetermined period prior to the proposed meeting date and time;
receiving a conference call confirmation instruction, a delay instruction, or a cancellation instruction;
responsive to receiving the delay instruction, sending a delay instruction to the first remote device for processing;
establishing a delayed call-in time at the first remote device broadcasting a status message to each meeting attendee utilizing the first remote device;
automatically calling the conference call dial-in number using the first remote device at the at the delayed call-in time;
establishing a first network connection between the first remote device and a second remote device;
transmitting the conference call meeting identification number from the first remote device to the second remote device over the first network connection;
automatically calling the attendee call-back number using the first remote device;
establishing a second network connection between the first remote device and an attendee telephone; and
linking the attendee telephone to the second remote device to join a conference call.

21. The method of claim 20, wherein scanning a contents of the meeting request notification message comprises extracting attendee identification information for each meeting attendee.

22. The method of claim 20, further comprising appending a user location information to the status message.

23. The method of claim 22, wherein the user location information is a location map indicating a present location of the user.

24. The method of claim 20, wherein the status message is an email or SMS message

25. The method of claim 20, further comprising scanning a contents of a meeting request notification message to identify a user identification number and automatically transmitting the user identification number from the first remote device to the second remote device over the first network connection.

26. The method of claim 20, wherein the attendee telephone is a mobile phone or a landline telephone.

27. The method of claim 20, wherein the attendee telephone and the attendee computing device are integrated in a smartphone device.
